(19) United States
(12) Patent Application Publication
(10) Pub. No.: US 2002/0148044 A1
(43) Pub. Date: Oct. 17, 2002

(54) Patient support

(76) Inventors: Stephen Hayes, West Midlands (GB); Stephen Hollyoak, West Midlands (GB)

Correspondence Address: Brown Raysman Millstein, Felder & Steiner, 900 Third Avenue, New York, NY, 10022, US

(21) Appl. No.: 10/009,743

(22) PCT Filed: Apr. 4, 2001
(86) PCT No.: PCT/GB01/01544

(30) Foreign Application Priority Data
Apr. 4, 2000 (GB) 0008065.5
Jun. 6, 2000 (GB) 0013588.9

(51) Int. Cl. A61G 7/005; A61G 7/015

(52) U.S. Cl. 5/618; 5/610; 5/616

(57) ABSTRACT

A patient support apparatus comprises a base frame (10) supporting lifting arms (15) on either side. The lifting arm (15) at on end of the base frame (10) is connected by a pivoting and sliding joint (8) and the lifting arm (15) at the other end by a pivoting joint (7). The lifting arms (15) support an upper frame (20), via pivoting and sliding joints (16). Stabilizing links (5, 6) are connected to the middle of each lifting arm and to the upper frame. Linear actuators (30, 31) act on the top ends (16) of the lifting arms (15) to raise, lower or tilt the upper frame (20). The mechanism achieves an exceptionally low minimum height whilst still maintaining hoist clearance under the base frame (10). The upper frame (20) may be moved to a variety of working heights and achieves high angles of Trendelenburg tilts.

The invention relates to patient support apparatus especially but not exclusively to hospital beds, patient trolleys, physiotherapy couches or the like.

It is known to have a profiling patient support in which the mattress support is so arranged that it comprises two or more parts hinged together wherein angular adjustment of the individual parts provides an optimum position for patient comfort and/or nursing. similarly, the mattress support may also be adjustable with respect to its height and tilt for nursing and certain medical/physiotherapy procedures. Examples of such beds are to be found in Patents EP 0488552 and EP 0498111 which show the use of powered actuators to provide articulation for variable height and tilt, and also profiling of the patient support surface.

However, these beds or trolleys, due to the design of the bed raising and lowering mechanisms do not provide a very low mattress to floor height with good ground clearance for access for patient moving, monitoring or treatment systems. The beds or trolleys have a minimum height to the top of the mattress support platform of 400 mm. The aim of the present invention is to reduce this minimum height even lower to provide the ideal height for patient entrance/exit or transfer.

Accordingly, the invention provides a patient support apparatus comprising a base frame supporting an upper frame, the upper frame having a platform for supporting a mattress or the like, at least a pair of support arms interconnecting the base frame and the upper frame, each of the arms pivotally connected to a respective end of the base frame and extending towards the opposite end of the upper frame, at least one of the arms also capable of sliding motion along the base frame, both arms connected to the upper frame to position the upper frame in a minimum position where the arms are fully collapsed to lie within the base frame to positions where both of the arms are elevated to same or varying degrees to provide varying heights as well as angles of tilt of the upper frame. The arrangement of the arms provides an exceptionally low height of the support platform whilst also providing a clear space underneath the base frame for hoists.

Preferably, the arms are actuated by at least one actuator, said actuator(s) being preferably mounted on the same plane within the upper frame so as to lie within the upper frame. In this way the arms are totally unhindered in their travel from the minimum position of the platform to the maximum position and the whole arrangement is compact without trailing cables, etc. More preferably, all of the actuators are arranged to operate in a longitudinal direction parallel to the upper frame without any pivotal movement, resulting in a structure without bending moments to the actuators and thus less wear and tear on the actuators.

Preferably, the actuators are all located centrally within the upper frame and more preferably are housed within a single housing, the housing also providing structural support to the actuators. More preferably said housing is arranged to span transversely centrally of the upper frame and located almost entirely within the upper frame.

The location of all the height, tilt and profiling actuators in a single housing, within the upper frame enables the very low mattress to floor height of the invention but additionally, the single housing is the only enclosure that requires sealing to prevent ingress of water during cleaning or body fluids during use, as opposed to several items on a conventional patient support surfaces, for example, hospital beds or trolleys. Furthermore, with the housing preferably providing a structural casing for all the actuators, thereby eliminating the need for individual actuator casings, the overall number of components are minimised with the consequent benefits of reduced cost of manufacture.

Preferably, the housing may be located substantially under the seat section of the platform and optionally may be integral with the seat section of the platform to provide improved structural rigidity to the upper frame.

Preferably, the actuators are controlled by control means also located within the housing.

Preferably, the housing as a unit may be secured to the upper frame by releasable fastenings to allow for removal of the housing from the upper frame for servicing or enhancement of the actuators and components housed within.

Preferably the support arms may be collapsible to position the patient support to the minimum position solely under the weight of the patient support. This provides for mechanical emergency operation of the patient support in the cardio-pulmonery resuscitation (CPR) position in the absence of power supply or power failure.

Preferably, the support arms are provided with spring means assisting the lifting action of the actuators, thereby enabling smaller, less expensive actuators to be used for the same load.

Preferably, one or both actuators are adapted to be operable mechanically to allow the upper frame to be lowered or tilted manually, in the event of power failure.

The present invention will now be described in detail, by way of example only, with reference to the accompanying drawings in which:

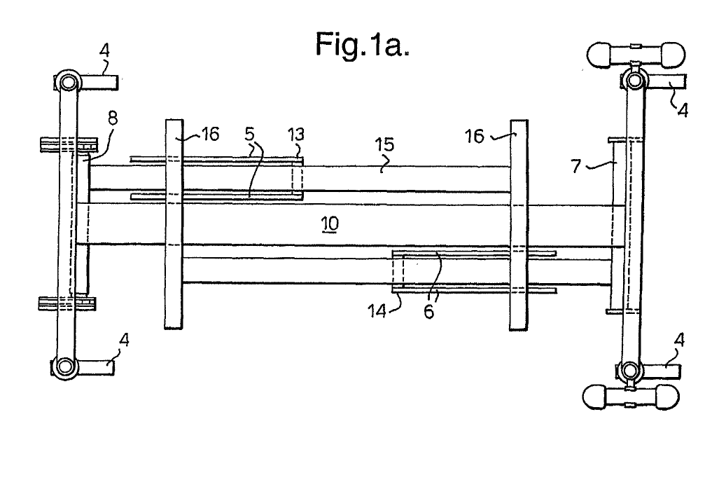

FIG. 1a is a plan view of the support arms and the base frame according to the invention;

FIG. 1b is a plan view of the support arms and base frame of a preferred embodiment of the invention;

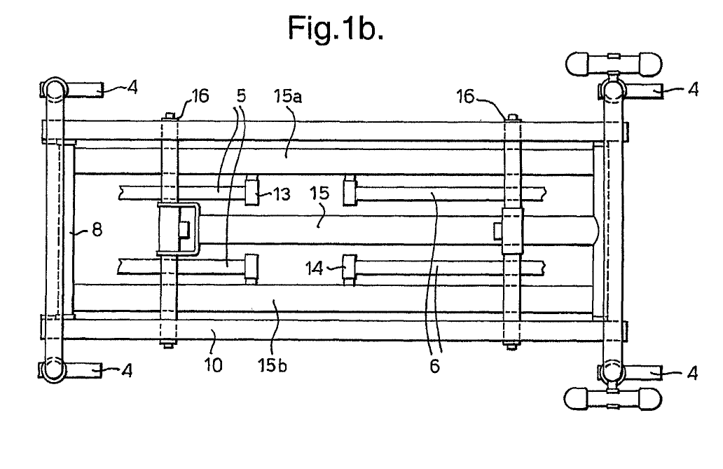

FIG. 2 is a side view of the patient support in an elevated position according to the invention;

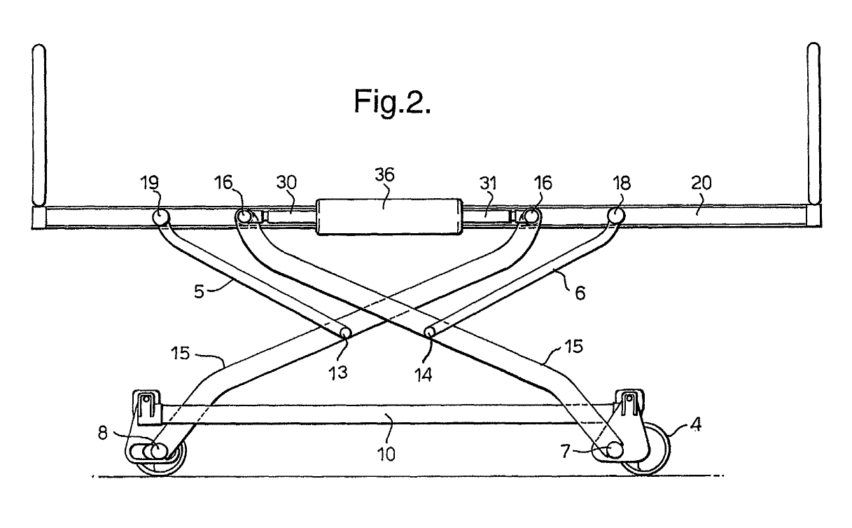

FIG. 3 is a side view of the patient support in the minimum lowered position according to the invention;

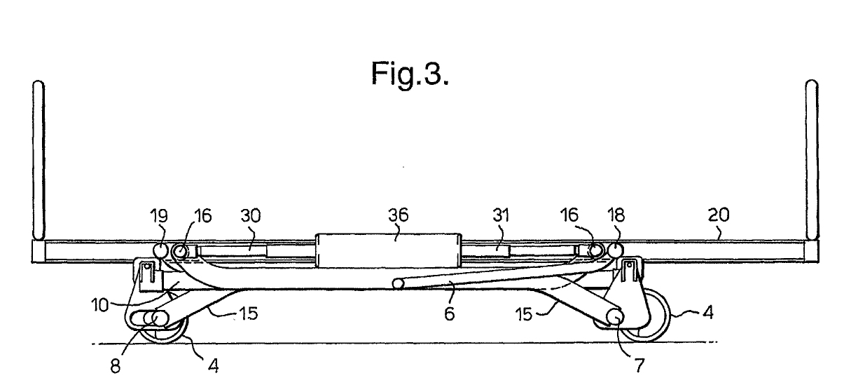

FIG. 4 is a side view of the patient support in a tilted position according to the invention;

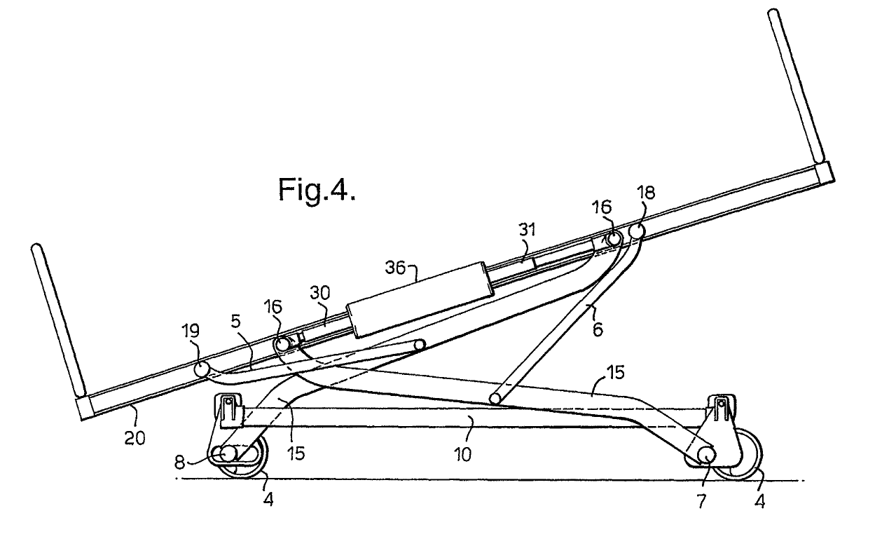

FIG. 5 is a plan view of the upper frame in FIG. 2 showing schematically the control housing and actuators;

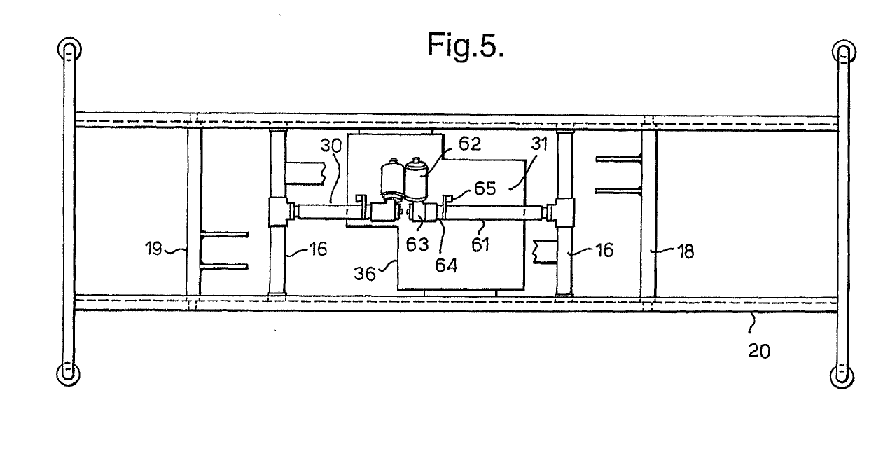

FIG. 6 is a plan view of the upper frame in FIG. 5 showing schematically a manual override system; and

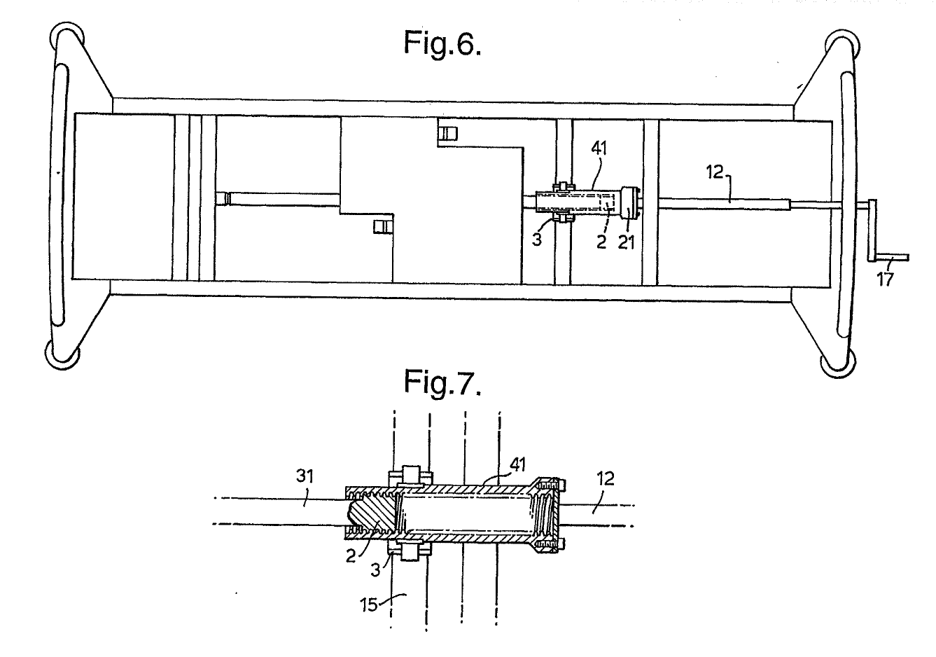

FIG. 7 is an enlarged view of the adjustment screw in FIG. 6.

Referring to FIG. 1a, the base frame 10 consists of two base end castings 11 joined by central base member 12, which is either a rolled section or extrusion. Four interlinked castors 4 are inserted into the base end castings 11 with the mechanism hidden internally in the castings and the central base member 12. An optional fifth tracking castor 5 may also be fitted in the central base member 12, as shown in FIG. 2.

At one end of the base frame 10, is connected a lifting arm 15 via a pivoting and sliding joint 8, in another embodiment (see FIG. 1b), said lifting arm 15 may include members 15a, 15b. At the other end of the base frame 10 lifting arm 15 is connected via a pivoting joint 7. At the top end of each lifting arm 15 (15a, 15b) is a cross-tube 16 into which are fitted two roller followers 17, one at either end of the cross tube 16.

As shown schematically in FIG. 2, the lifting arms 15 (15a, 15b) support the upper frame 20 by means of the roller followers 17 at each end of the cross tubes 16 co-operating with linear channels 18 on the sides of the upper frame 20. The top ends of the lifting arms 15 (15a, 15b) are pivotally connected to the cross tubes 16. Stabilising links 5 and 6 are connected to the lifting arms 15-(15a, 15b) via pivoting joints 13 and 14 and are connected to the upper frame 20 via pivots 18 and 19. The cross tubes 16 are each connected to a linear actuator 30, 31 connected to suitable power supplies and to a central control housing 36 as explained later. The actuators 30, 31 upon extension or retraction push or pull the respective cross tubes 16 along the channels 18 by means of rollers 17.

When the cross tubes 16 connecting the top ends of the lifting arms 15 (15a, 15b) are pulled simultaneously then the upper frame 20 will rise at a level setting and a similar reverse action will produce a movement of the upper frame 20 in the reverse direction to the lowest position where the upper frame rests upon the base frame with the actuators and lifting arms nested in between the two frames as closely as possible (see FIG. 3). During this motion, the bottom end of lifting arms 15 does not move horizontally at joint 8 on the base frame 10 in relation to the bottom end of the other lifting arm 15.

However, if the two actuators 30 and 31 are extended or retracted by unequal lengths as shown in FIG. 4 then the upper frame 20 will tilt relative to the floor. During this motion, the bottom end of the lifting arm 15 will move horizontally at joint 8 in relation to the bottom end of the other lifting arm 15. Stabilising links 5 and 6 respectively eliminate any unwanted movement in the mechanism.

The resultant mechanism achieves an exceptionally low minimum height, whilst still maintaining good hoist clearance under the base frame 10. The mechanism enables the upper frame to be used at a wide range of working heights as well high angles of Trendelenberg and reverse Trendelenberg tilts. Another advantage of the mechanism is that the support arms would always tend to move apart and therefore are able to collapse safely under the weight of the platform to position the platform to the minimum position. This provides for mechanical emergency operation of the patient support in the cardio-pulmonery resuscitation (CPR) position in the absence of power supply or power failure.

In order to provide some assistance at the very low height, spring loaded plungers 71,72 are rigidly mounted to the upper frame 20, one at either end and their length is such that when the upper frame 20 is lowered towards minimum height the top ends of the lifting arms 15 (15a, 15b) come into contact with them via the cross tubes 16. As the upper frame 20 moves toward minimum height, the springs 71,72 are compressed in length, thereby building up a stored horizontal force against the top end of the lifting arms 15 (15a, 15b) . When the upper frame. is subsequently raised from minimum height, the stored energy from the springs 71,72 assists the lift actuators 30,31 over the initial part of their lift motion. The benefit of this arrangement is that smaller lift actuators can be used to lift the upper frame 20 and patient support, in comparison to the size of lift actuator required if the springs 71,72 were not present.

The springs 71,72 could be made longer to act over the entire range of lift of the upper arms 15(15a, 15b), but the length of the springs required may make this impractical.

Rather than using compression springs as shown, gas springs could be used in a similar situation. Tension springs could be used if applied in the opposite direction.

FIG. 5 shows the patient support control system 35 housed in a control housing 36 situated approximately at the centre of the upper frame 20 and mounted directly or structurally integral to it.

The control housing 36 may be constructed as a casting or moulding and houses the linear actuators 30, 31 for adjustment of the height of the upper frame 20 and any others may be added for movement of the mattress platform to be supported by the upper frame 20.

The control housing 36 may incorporate additional structural reinforcement in order to transmit all forces through to its connection with the upper frame 20.

The actuators 31 and 32 are fitted into this housing and are located on the same plane. Since the actuators are mounted for truly linear operation without any pivotal movement both the actuators may be fixedly secured to the control housing 36. Each actuator consists of a screw tube assembly 61, incorporating a lead screw and nut assembly, which is driven by a motor 62 via a gear reduction unit 63. All axial loads are taken by a thrust bearing 64 rigidly mounted onto the control housing mouldings.

Positional feedback of actuator stroke is measured by potentiometers 65 coupled to the actuator lead screw via gears or belts. Alternatively, positional feedback may be attained by other conventional means, for example pulse encoders.

The actuators may be fitted with spring clutches to, facilitate freewheeling, and/or spring brakes to prevent backdriving in normal operation.

Batteries 75 may be included for emergency operation of the patient support functions and may be housed in a sealed compartment within the housing 36. The battery compartment may be externally vented to prevent build up of gases.

If both mains power and battery backup fail when the upper frame 20 is tilting in the foot end down position, it could in certain circumstances be necessary to bring the upper frame 20 back into a level position or preferably into some degree of tilt with the head end down. In these circumstances a manual means of operating the upper frame 20 is provided to as shown in FIGS. 6 and 7.

The manual lift is via a rotating handle, in order that the mechanical effort required stays within manual handling requirements.

The foot end lift actuator 31 has a threaded rod end 2, which screws into the screw housing 41. The actuator rod extends from the actuator housing body but does not rotate in relation to it. The screw housing 41 mounts into trunnion 3 which itself mounts into the end of the foot end lifting arm 15. Attached to the screw housing 41 is the operating rod 12, into which fits a telescopic operating handle 17.

With the upper frame 20 tilted towards the foot end, the operating handle 17 is rotated to level the upper frame 20. As the operating handle 17 is rotated, it in turn rotates the screw housing 41. As a result the screw housing 41 travels along the longitudinal axis of the upper frame 20, due to effect of the threaded rod end 2 of the actuator 31. This results in the foot end lifting arm 15 being lowered, bringing the upper frame 20 to a level position. The trunnion 3 allows for the relative rotation between the lifting arm 15 and screw housing 41 as the lifting arm 15 is lowered.

The limit switch 21 is mounted between the screw housing 41 and actuator rod end 2. The switch 21 monitors whether the manual override has been operated, as it is important that the mechanism is returned to its normal condition before the patient support is electrically operated. This is necessary as clash conditions between the upper frame 20, floor and base frame 10 could occur if the mechanism is not returned to its normal position before operation. The limit switch 21 would be connected into the patient support control system 35.

A mechanism similar to that described could be fitted to either the head end of the bed, the foot end of the bed or both.

The control housing 36 may further accommodate other elements of the control system, for example, sensors, load cells, specific software for controlling the patient support, and a light for illuminating the floor around the patient support.

Although the preferred method of actuation is electromechanical, hydraulic cylinders may be used as actuators, being supplied by a pump unit, the actuators and pump all located within the control housing 36.

Another alternative form of actuation may comprise drive screws being driven by a motor all housed centrally within the control housing 36.

1. A patient support apparatus comprising a base frame supporting an upper frame, the upper frame for supporting a mattress platform or the like, at least a pair of support arms interconnecting the base frame and the upper frame, each of the arms pivotally connected to a respective end of the base frame and extending towards the opposite end of the upper frame, at least one of the arms also capable of sliding motion along the base frame, both arms connected to the upper frame to position the upper frame in a minimum position where the arms are fully collapsed to lie within the base frame to positions where the arms are respectively elevated to same or varying degrees to provide varying heights and angles of tilt of the upper frame.

2. A patient support apparatus as claimed in claim 1 wherein the support arms are actuated by at least one actuator, said actuator(s) being mounted on the same plane within the upper frame so as to lie within the upper frame.

3. A patient support apparatus as claimed in claim 2 wherein the actuators are arranged to operate in a longitudinal direction parallel to the upper frame without any pivotal movement.

4. A patient support apparatus as claimed in any preceding claim wherein the actuators are all located centrally within the upper frame, in a single housing.

5. A patient support apparatus as claimed in claim 4 wherein the housing also provides structural support to the actuators.

6. A patient support apparatus as claimed in claims 4 or 5 wherein said housing is arranged to span transversely centrally of the upper frame and located almost entirely within the upper frame.

7. A patient support apparatus as claimed in any preceding claim wherein the actuators are controlled by control means also located within the housing.

8. A patient support apparatus as claimed in any preceding claim wherein the support arms are collapsible to position the upper frame to the minimum position solely under the weight of the patient support.

9. A patient support apparatus as claimed in any preceding claim wherein the support arms are provided with spring means to assist in the lifting action of the actuators.

10. A patient support apparatus as claimed in any preceding claim wherein one or more actuators are operable mechanically to allow manual lowering or tilting of the upper frame, in the event of power failure.
